(19) United States
(12) Patent Application Publication
(10) Pub. No.: US 2014/0044954 A1
(43) Pub. Date: Feb. 13, 2014

(54) FOAMED RESIN MOLDED ARTICLE

(71) Applicants: Hiroo Matsubara, Nagoya (JP); Yasukazu Ohno, Nagoya (JP); Mitsuo Hosokawa, Nagoya (JP)

(72) Inventors: Hiroo Matsubara, Nagoya (JP); Yasukazu Ohno, Nagoya (JP); Mitsuo Hosokawa, Nagoya (JP)

(73) Assignee: HAYASHI ENGINEERING INC., Nagoya (JP)

(21) Appl. No.: 14/114,180

(22) PCT Filed: Apr. 12, 2012
(86) PCT No.: PCT/JP2012/060016

§ 371 Date: Oct. 25, 2013

(30) Foreign Application Priority Data
Apr. 28, 2011 (JP) 2011-101712

(51) Int. Cl. B29C 45/00; B32B 5/20

(52) U.S. Cl. CPC B29C 45/0001; B32B 5/20
USPC 428/318.8; 264/41

(57) ABSTRACT

There is provided a foamed resin molded article having many microscopic foamed cells formed therein. The foamed resin molded article (1) of the present invention has its surface formed of a skin layer (2) and has its interior formed of a foamed layer (3). The foamed layer (3) has a plurality of first foamed cells (4) and a plurality of second foamed cells (5) formed therein, the plurality of second foamed cells (5) being formed between the first foamed cells (4) and being smaller than the first foamed cells (4).

### TECHNICAL FIELD

The present invention relates to a foamed resin molded article molded by an injection foaming molding method or the like.

### BACKGROUND ART

At present, given the high level of environmental awareness, there is growing need to reduce automobile weight in order to improve fuel consumption. To address this issue, there are cases where a lightweight foamed resin molded article is used as the base material for an automobile part, such as a door trim, to thereby reduce the automobile weight. The foamed resin molded article is preferable in terms of not only reducing weight but also reducing material cost, so the employment of the foamed resin molded article in the automobile parts tends to be on the increase.

As the foamed resin molded article is higher in the proportion of bubbles (foamed cells), that is, higher in an expansion ratio, the foamed resin molded article is lighter in weight, and as the foamed resin molded article is smaller as regards the diameter of the foamed cell, the foamed resin molded article has better physical properties such as resistance to impact. For this reason, it is desirable that the foamed cells that are formed in the foamed resin molded article be small in diameter and large in number.

A method for molding a foamed resin molded article is broadly classified into two methods that include a physical foaming method and a chemical foaming method.

The physical foaming method is a method for dissolving air, carbon dioxide, nitrogen, or volatile solvent, which is pressurized in the cylinder of an injection molding machine, in a resin.

The chemical foaming method is a method for putting a base material and a chemical foaming agent into an injection molding machine from its hopper and for mixing gas such as carbon dioxide gas, nitrogen, water, or ammonium, which is generated by thermal decomposition or chemical reaction, into resin.

In the physical foaming method, pressure and temperature can be easily regulated and hence the carbon dioxide or the nitrogen, which is brought into a supercritical state, can be directly injected into the resin. A supercritical fluid has compressibility like liquid and diffusibility like gas and hence can give high diffusibility and high solubility to the carbon dioxide or the nitrogen. In this way, a foamed resin molded article can be produced in which an extremely large number of foamed cells each having an extremely small diameter are formed.

In the physical foaming method, however, gas needs to be prepared and, in addition, a mechanism is needed for dissolving the gas in the resin and a mechanism is needed for maintaining pressure so as to prevent the gas from coming out of the resin before molding. For this reason, a user needs to introduce a new injection molding machine or to modify an existing injection machine. Hence, injection molding by the physical foaming method presents a large problem of increasing cost such as initial investment and maintenance.

In the chemical foaming method, gas is generated by the chemical reaction and hence the pressure to dissolve the gas is low, which hence makes it difficult to dissolve a large amount of gas in the resin. As a result, the size of the foamed cells is increased.

In the foaming injection molding, for the purpose of reducing the hole diameters of the foamed cells in the foamed resin molded article and increasing the number of foamed cells, a nucleating agent is added to the resin. This is based on the feature in which the bubbles are generated from the starting points on the surface of a physical body. The number of starting points from which the bubbles are generated can be increased in number by the nucleating agent, so that in the chemical foaming method, the nucleating agent is especially effective.

An organic substance based on citric acid or the like has been used as the nucleating agent. However, the organic substance like this is decomposed by heat to thereby produce a tar-like substance. In the chemical foaming, a certain level of high temperature is required for the foaming agent to be decomposed to thereby produce gas. Depending on the kind of the foaming agent, in some cases, the temperature becomes higher than the temperature at which the nucleating agent made of the organic substance is decomposed or impaired. In these cases, the decomposed or impaired nucleating agent damages the external appearance of the surface of the foamed resin molded article and makes the foamed cells coarse, and moreover, causes smell to be generated, which hence significantly reduces the marketability of the foamed resin molded article.

Furthermore, even in the case where the temperature at which the foaming agent is decomposed to thereby produce gas is not higher than the temperature at which the nucleating agent is decomposed or impaired, when molding processing is continuously performed for a long time, in particular, in injection molding, the nucleating agent made of the organic substance is impaired and is gradually attached to a screw and the like of the injection molding machine. For this reason, the attached material prevents the rotation of the screw and causes the injection molding machine to fail. Hence, it is not desirable to use the nucleating agent made of the organic substance like this.

Hence, in order to make the nucleating agent resistant to heat, not the organic substance but an inorganic substance is used as the nucleating agent, or a material made by using the organic substance and the inorganic substance together is used as the nucleating agent.

A patent document 1 showing one example of a chemical foaming method discloses a technique of mixing a foaming agent and an inorganic compound powder into a melted resin, the inorganic compound powder being made of particles having a diameter of from 2 μm to 50 μm, particularly preferably, from 5 μm to 20 μm and made of calcium carbonate, talc, mica, which will become a nucleating agent.

### TECHNICAL DOCUMENT OF THE RELATED ART

### Patent Document

Patent document 1: Japanese Patent Laid-Open No. 2008-13780

### SUMMARY OF THE INVENTION

### Problems that the Invention is to Solve

In the patent document 1 described above, talc of an inorganic substance having a particle diameter of approximately from 1 μm to 100 μm is used as the nucleating agent. The nucleating agent has the effect of increasing the number of bubbles but cannot increase the number of bubbles to a number large enough to form a cell structure having an extremely large number of microscopic foamed cells in the foamed resin molded article that is to be molded.

Furthermore, as can be seen from the growth process of the bubbles shown in FIG. 1A and FIG. 1B, when the expansion ratio is increased, many bubbles 22 are generated on the surface of the nucleating agent 21 (see FIG. 1A) and then a plurality of bubbles 22 are combined with each other in the growth process of the bubbles, thereby being brought into a large bubble 23 in the end (see FIG. 1B). For this reason, in chemical foaming, a foamed resin molded article having microscopic foamed cells formed therein has never been realized up to now.

The present invention has been made in view of the problems described above and the object of the present invention is to provide a foamed resin molded article having an extremely large number of microscopic foamed cells formed therein.

### Means for Solving the Problems

A foamed resin molded article of the present invention has a surface formed of a skin layer and has an interior formed of a foamed layer. The foamed layer is formed of a plurality of first foamed cells and a plurality of second foamed cells which are formed between the first foamed cells and which are smaller than the first foamed cells.

### Effects of the Invention

According to the present invention, many microscopic foamed cells can be formed in the foamed layer of the foamed resin molded article and the resistance to impact and rigidity of the foamed resin molded article can be improved.

### BRIEF DESCRIPTION OF THE DRAWINGS

FIG. 1A is an illustration to show a state in which bubbles grow and illustrates a state in which bubbles are generated on the surface of a nucleating agent.

FIG. 1B is an illustration to show a state in which bubbles grow and illustrates a state in which bubbles are combined with each other, thereby being brought into one large bubble.

FIG. 2 is a photograph (42-fold magnification) taken of a section of a foamed resin molded article of an exemplary embodiment 1 according to the present invention by the use of a microscope.

FIG. 3 is a photograph (1000-fold magnification) taken of a section of a foamed resin molded article of the exemplary embodiment 1 according to the present invention by the use of a scanning electron microscope (SEM).

FIG. 4 is a photograph (3000-fold magnification) taken of a section of a foamed resin molded article of the exemplary embodiment 1 according to the present invention by the use of a scanning electron microscope (SEM).

FIG. 5 is a photograph (42-fold magnification) taken of a section of a foamed resin molded article of a comparative example 1 by the use of a microscope.

FIG. 6 is a photograph (1000-fold magnification) taken of a section of a foamed resin molded article of the comparative example 1 by the use of a scanning electron microscope (SEM).

FIG. 7 is a photograph (3000-fold magnification) taken of a section of a foamed resin molded article of the comparative example 1 by the use of a scanning electron microscope (SEM).

FIG. 8 is a schematic view to illustrate a test method of a cold-resistant falling-ball impact test.

FIG. 9 is a table to show a test result of the cold-resistant falling-ball impact test and an evaluation test of flexural properties.

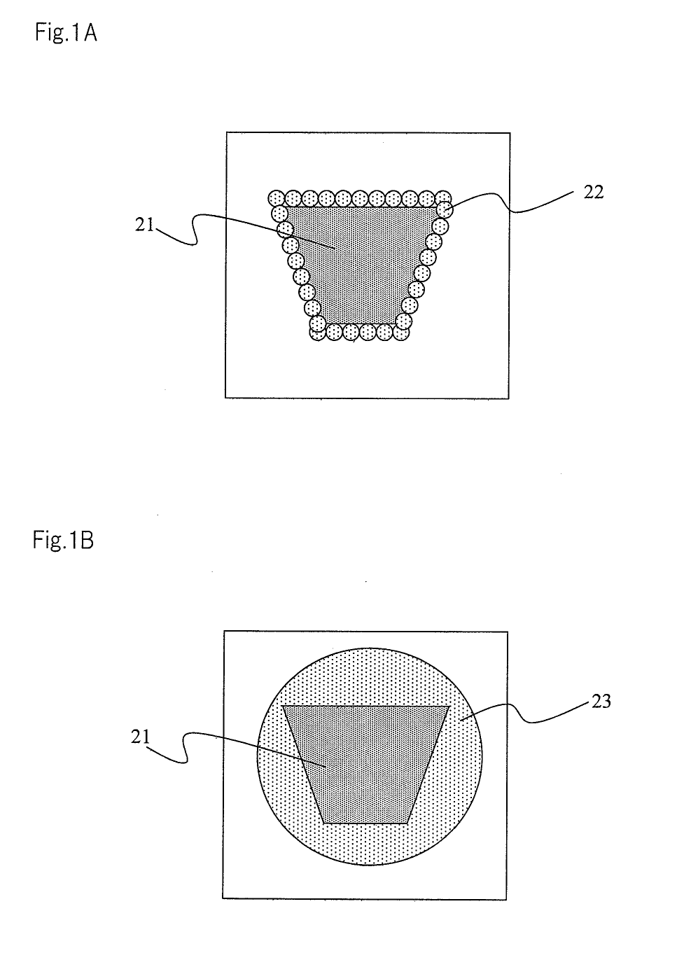

### MODE FOR CARRYING OUT THE INVENTION

Hereinafter, embodiments of the present invention will be described on the basis of the accompanying drawings. Here, constructions having the same function are denoted by the same reference numerals and their descriptions are omitted in some cases.

A foamed resin molded article molded by the present invention can be obtained by injection foam-molding a mixture made by mixing a foaming agent into a thermoplastic resin, which becomes a base resin, and further mixing a complex as a nucleating agent, the complex being formed by attaching a second nucleating agent, which has a smaller average particle diameter than a first nucleating agent, to the surface of the first nucleating agent.

### [Base Resin]

Polyolefin-based resin, such as polypropylene and polyethylene, can be preferably used as the base resin of the present invention, but the base resin is not limited to this. For example, the following substances can be used: polystyrene-based resin such as polystyrene, ABS (arcylonitrile butadiene styrene copolymer) resin, AS (arcylonitrile styrene copolymer) resin; polyamide-based resin such as nylon 6, nylon 66, and nylon 12; polyester-based resin such as polyethylene terephthalate (PET), polybutylene terephthalate (PBT), polytrimethylene terephthalate (PTT), polyethylene naphthalate (PEN), and polylactic acid; polyvinyl chloride (PVC); polycarbonate (PC); polyacetal (POM); polyimide; and polyetheretherketone (PEEK). These base resins may be denatured. Furthermore, two or more kinds of resins may be used together.

### [Foaming Agent]

The foaming agent of a thermal cracking type or a reaction type by a chemical foaming agent can be used as the foaming agent of the present invention. Specifically, azo compound such as azodicarbonamide; nitroso compound such as N,N-dinitrosopentamethylenetetramine; hydrazine derivative such as 4,4-oxybis(benzensulfonylhydrazide) and hydrazodicarbonamide; bicarbonate such as sodium hydrogencarbonate; carbonate such as sodium carbonate and ammonium carbonate; nitrite such as ammonium nitrite; semicarbazide compound; azide compound; tetrazole compound; isocyanate compound; or hydroxide can be preferably used. Furthermore, a foaming assistant such as urea and an organic nucleating agent or inorganic nucleating agent such as sodium citrate, talc, or calcium carbonate may be added together. As to the foaming agent, two or more kinds of foaming agents may be used together. In particular, a masterbatch of sodium hydrogencarbonate and sodium citrate of the nucleating agent can be preferably used.

### [First Nucleating Agent]

As described above, the nucleating agent of the present invention is made of a complex of a first nucleating agent and a second nucleating agent having a smaller average particle diameter than the first nucleating agent. Each of the first nucleating agent and the second nucleating agent, which will be described later, functions as the starting point at which a bubble, which is to be a foaming cell of the foamed resin molded article, is generated.

The first nucleating agent includes: silicate such as talc, mica, silica, clay, montmorillonite, and kaolin; sodium carbonate such as calcium carbonate, lithium carbonate, and magnesium carbonate; metallic oxide such as alumina, titanium oxide, and zinc oxide; metal such as aluminum, iron, silver, and copper; hydroxide such as aluminum hydroxide and magnesium hydroxide; sulfide such as barium sulfide; carbonate such as charcoal and bamboo charcoal; and titanate such as potassium titanate and barium titanate. Of these substances, in particular, talc can be more preferably used.

The particle diameter of the first nucleating agent made of the inorganic substance described above is preferably from 0.5 μm to 1000 μm, more preferably, from 1 μm to 10 μm. When the particle diameter is not less than 0.5 μm, microscopic particles of the first nucleating agent can be easily formed. Furthermore, when many particles of nano-size (smaller than 1 μm) of the second nucleating agent are attached to the surface of the first nucleating agent, the first nucleating agent can be made to function as a carrier for dispersing the second nucleating agent in the base resin. Furthermore, when the particle diameter is not larger than 1000 μm, it is possible to prevent a degradation in physical property and a degradation in appearance in the foamed resin molded article after molding.

Furthermore, a fiber powder made of the following substances can be used as the first nucleating agent in place of the inorganic substance such as talc: plant fiber; cellulose fiber; cellulose acetate fiber; polyethylene terephthalate fiber; nylon fiber; polyethylene naphthalate fiber; aramid fiber; vinylon fiber; or polyarylate fiber.

This fiber powder may be made of a composite fiber of a core-sheath type or a side-by-side type so as to improve dispersibility into the base resin and adhesive properties to the base resin. Furthermore, the fiber powder may be made of a fiber of a hollow type so as to reduce weight and to improve heat resistance.

It is preferable that the fiber powder be made of micro fibers having an average fiber diameter of from 0.5 μm to 250 μm and an average fiber length of from 1 μm to 3000 μm. Further, it is more preferable that the fiber powder be made of micro fibers having an average fiber diameter of from 1 μm to 100 μm and an average fiber length of from 10 μm to 500 μm. Furthermore, it is still more preferable that the fiber powder be made of micro fibers having an average fiber diameter of from 1 μm to 40 μm and an average fiber length of from 20 μm to 300 μm.

### [Second Nucleating Agent]

The second nucleating agent includes: silicate such as talc, silica, clay, montmorillonite, and kaolin; sodium carbonate such as calcium carbonate, lithium carbonate, and magnesium carbonate; metallic oxide such as alumina, titanium oxide, and zinc oxide; metal such as aluminum, iron, silver, and copper; hydroxide such as aluminum hydroxide and magnesium hydroxide; sulfide such as barium sulfide; carbonate such as charcoal and bamboo charcoal; titanate such as potassium titanate and barium titanate; cellulose such as cellulose microfibril and cellulose acetate; and carbon such as fullerene and carbon nanotube. Of these substances, one kind may be used by itself or two or more kinds may be used together. Of these substances, calcium carbonate, mica, montmorillonite, or titanium oxide is preferably used. In particular, calcium carbonate can be more preferably used because nano size particles can be made or acquired comparatively easily and at low cost.

The second nucleating agent may be formed in a spherical shape, a plate shape, a fiber shape, or a hollow shape. Furthermore, fine particles of a specified shape may be used by themselves or fine particles of two or more kinds of different shapes may be used together. In this regard, the second nucleating agent of the present invention includes not only primary particles but also secondary or more particles if they are within a range of size (particle diameter) of the second nucleating agent, which will be described later.

As to the size of the second nucleating agent, an average particle diameter needs to be a nano size less than 1 μm. Specifically, the average particle diameter is from 10 nm to 50 nm. When the average particle diameter is not less than 10 nm, the average particle diameter has an advantage in terms of the dispersibility of the second nucleating agent, whereas when the average particle diameter is not more than 500 nm, the average particle diameter has an advantage in terms of increasing a specific surface area, increasing a starting point from which bubble is generated, and refining a foamed cell. The size of the second nucleating agent is preferably from 20 nm to 200 nm, particularly more preferably, from 50 nm to 100 nm.

### [Complex of First Nucleating Agent and Second Nucleating Agent]

The first nucleating agent and the second nucleating agent, as described above, are mixed with the base resin as a complex formed in the state where the second nucleating agent is attached to the surface of the first nucleating agent.

A method for making the complex will be described as follows: the first nucleating agent and the second nucleating agent are previously powdered, or prepared by a precipitation method, to the size described above, respectively. Then, the first nucleating agent and the second nucleating agent are mixed with stearic acid for surface treatment, which will be described later, and stirred at high speeds by a Henschel mixer, whereby the complex can be acquired. It is preferable that the stirring be performed under dry conditions and at the circumferential speed of the rotating blades of not less than 20 m/s. In this way, a complex can be formed in which the second nucleating agent having a nano size is attached to the surface of the first nucleating agent so as to cover the surface of the first nucleating agent.

### [Method for Molding Foamed Resin Molded Article]

Next, one example of a method for molding a foamed resin molded article will be described. This molding method is only one example and it is not intended to limit the method for molding a foamed resin molded article to only this molding method. The above-mentioned base resin and the above-mentioned complex are put into a two-axis kneading extruding machine at the ratio of 1 to 80 by mass % (more preferably, 3 to 50 by mass %, particularly preferably, 5 to 20 mass %) of the complex to the weight of the base resin and then are mixed and kneaded. At this time, the complex is separated into the first nucleating agent and the second nucleating agent and is dispersed in the base resin, so that the second nucleating agent exists independently of each other and hence is prevented from being again aggregated. Furthermore, since the second nucleating agent is subjected to surface treatment by stearic acid so as to have hydrophobicity, the affinity of the second nucleating agent and the base resin becomes higher and hence the second nucleating agent is further resistant to being again aggregated.

At the time of mixing and kneading, if required, various kinds of additives such as pigment, rubber containing polymer, compatibility accelerator, plasticizer, lubricant, flame retardant, antibacterial agent, crystallization accelerator, antioxidant, ultraviolet absorber, heat stabilizer, surfactant, and antistatic agent may be blended.

As to a method for blending the complex with the base resin, a masterbatch may be made by blending the complex with a resin in high concentration and then the masterbatch may be further blended with the resin.

A masterbatch containing the base resin mixed with the complex, the foaming agent, and further, if required, pigment corresponding to a desired color variation of the foamed resin molded article, is dry-blended.

A dry-blended mixture is supplied to an injection molding machine and is injected into a space formed by two molds, that is, a cavity in the state where the foaming agent is inhibited from foaming under a specified pressure condition. Then, after a skin layer is formed, one mold is retracted from the other mold, whereby the density of the mixture is reduced and pressure is released, which is the so-called cavity expansion method. In this way, the foaming agent is decomposed and hence bubbles of carbon dioxide gas or nitrogen gas are generated from the starting points on the surfaces of the first nucleating agent and the second nucleating agent. These bubbles become foaming cells and foaming layers are formed and the foamed resin molded article is molded.

Here, a short shot method or an egression method may be employed as a method for molding a foamed resin molded article.

As described above, the first nucleating agent and the second nucleating agent are uniformly dispersed in the base resin. For this reason, in the foamed resin molded article according to the present invention, the first foaming cells by the bubbles generated on the surface of the first nucleating agent and the second foaming cells by the bubbles generated on the surface of the second nucleating agent are formed not partially but almost uniformly in the foamed resin molded article.

Next, the foamed resin molded articles molded by the molding method of the present invention (hereinafter referred to as an exemplary embodiment 1 and an exemplary embodiment 2) are compared with foamed resin molded articles molded by a molding method of a related art (hereinafter referred to as a comparative example 1 and a comparative example 2). In the comparative example 1, however, foaming is not developed and hence not a foamed resin molded article but a resin molded article is molded.

### Exemplary Embodiment 1

10 parts by mass of a complex of a first nucleating agent (talc) and a second nucleating agent (calcium carbonate) and 3 parts by mass of a foaming agent were mixed with 90 parts by mass of a polypropylene resin of a base resin to make a mixture, and then the mixture was injected, foamed, and molded in such a way that an expansion ratio became two, whereby a foamed resin molded article was molded. Here, the complex was acquired by stirring the first nucleating agent and the second nucleating agent at high speeds by the use of a Henschel mixer in such a way that the talc was 60% by mass and that the calcium carbonate was 40% by mass. In the talc of the first nucleating agent, the average particle diameter was 3.2 μm, whereas in the calcium carbonate of the second nucleating agent, the average particle diameter was 80 μm.

### Exemplary Embodiment 2

The complex included 75% of talc and 25% of calcium carbonate. A foamed resin molded article was molded under the same conditions as the exemplary embodiment 1.

### COMPARATIVE EXAMPLE 1

In a comparative example 1, a resin molded article was molded by using the polypropylene which was used as the base resin in the exemplary embodiment 1 and the exemplary embodiment 2 and by an injection molding method of the related art. The first nucleating agent, the second nucleating agent, and the foaming agent were not mixed and the foaming injection molding was not performed.

### COMPARATIVE EXAMPLE 2

In a comparative example 2, a polypropylene resin was used as a base resin as in the case of the exemplary embodiment 1 and the exemplary embodiment 2, and 3 parts by mass of a foaming agent and 10 parts by mass of a first nucleating agent were mixed with 90 parts by mass of the base resin to make a mixture, and then the mixture was injected, foamed, and molded in such a way that the expansion ratio became two, whereby a foamed resin molded article was molded. Here, talc was used as the first nucleating agent, as in the case of the exemplary embodiment 1 and the exemplary embodiment 2, but the second nucleating agent was not used. That is, the comparative example 2 is a foamed resin molded article by the related art.

In order to compare the foamed resin molded article of the exemplary embodiment 1 molded by the method described above with the foamed resin molded article of the comparative example 2 molded by the molding method of the related art, the sections of the foamed resin molded articles were observed by means of a microscope and a scanning electron microscope (SEM).

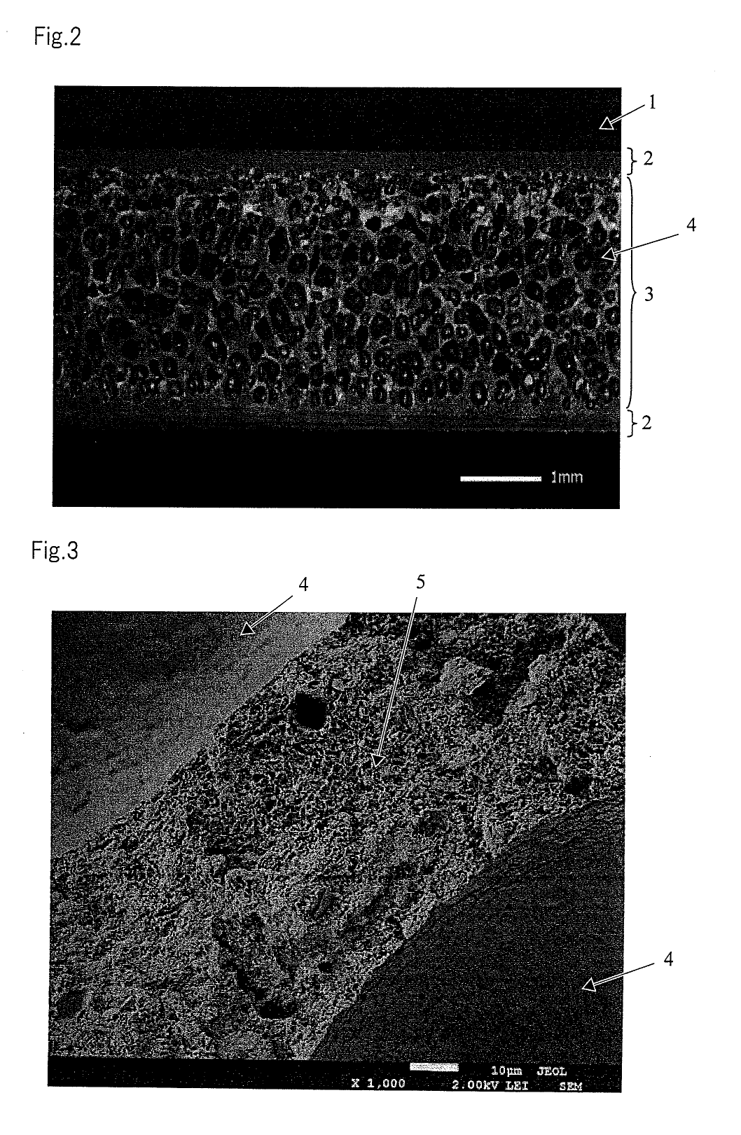

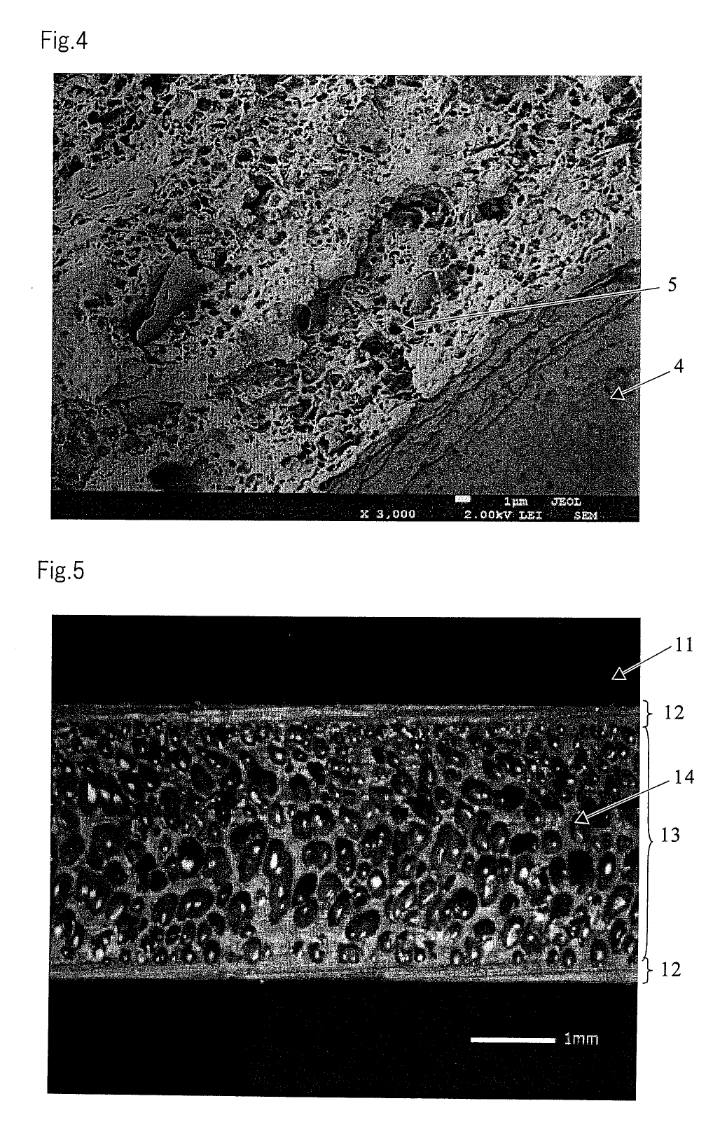

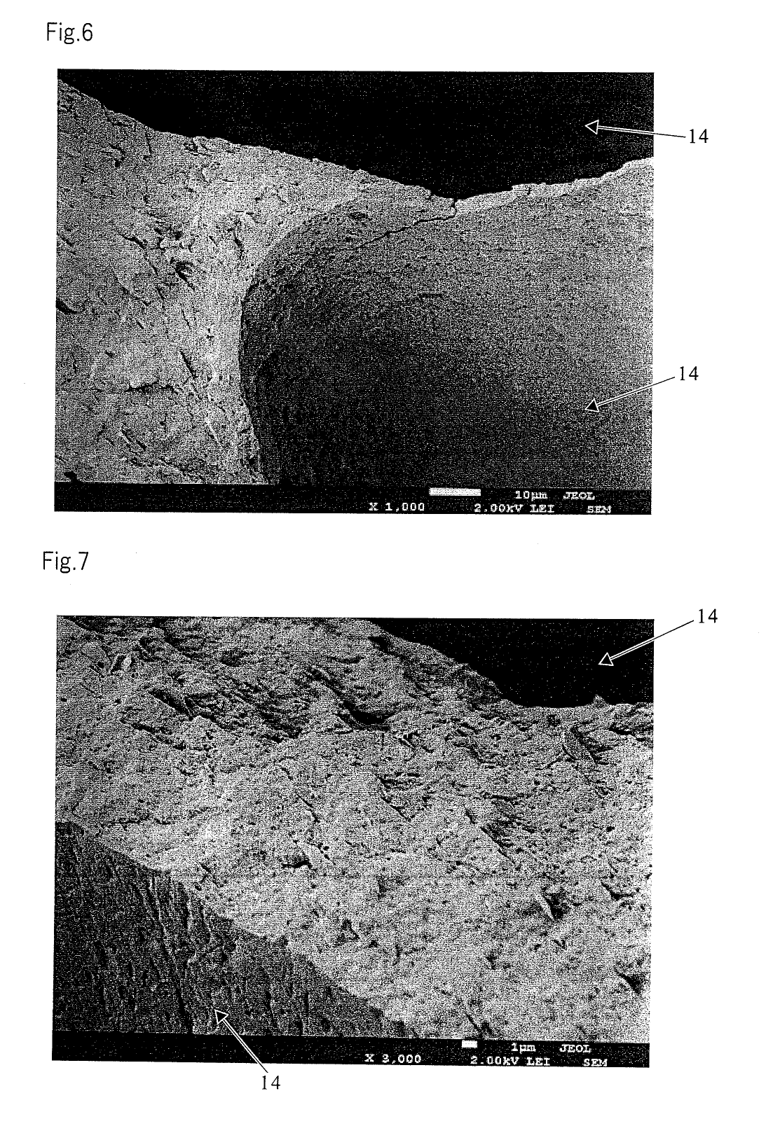

FIGS. 2 to 4 are magnified photographs of a section of the foamed resin molded article of exemplary embodiment 1, and the magnification is 17 times in FIG. 2, the magnification is 1000 times in FIG. 3, and the magnification is 3000 times in FIG. 4. Furthermore, FIGS. 5 to 7 are magnified photographs of a section of the foamed resin molded article of the comparative example 2, and the magnification is 17 times in FIG. 5, the magnification is 1000 times in FIG. 6, and the magnification is 3000 times in FIG. 7.

In exemplary embodiment 1, foamed resin molded article 1 having a thickness of approximately 3 mm is molded, and skin layers 2 each having a thickness of approximately from 0.2 mm to 0.6 mm are formed on the surface of foamed resin molded article 1. It can be seen that foamed layer 3 sandwiched between skin layers 2 has many first foamed cells 4 (foamed cells which can be seen in the foamed layer 3 shown in FIG. 2) formed by the first nucleating agent, first foamed cell 4 having a hole diameter of from 10 μm to 500 μm.

Furthermore, from FIGS. 2 to 4, it can be seen that in the exemplary embodiment 1, many microscopic second foamed cells 5 each having a hole diameter of approximately from 10 nm to 1000 nm are formed between the first foamed cells 4 (hereinafter referred to as “a cell wall”) by the second nucleating agent. In this regard, all of small holes of the cell walls that can be seen in FIG. 3 and small holes of the cell walls that can be seen in FIG. 4 are the second foamed cells.

On the other hand, in comparative example 2, foamed resin molded article 11 having a thickness of approximately 3 mm and skin layers 12 each having a thickness of approximately from 0.2 mm to 0.6 mm are formed on the surface of the foamed resin molded article 11. It can be seen that a foamed layer 13 sandwiched between the skin layers 12 has many first foamed cells 14 (foamed cells which can be seen in the foamed layer 13 shown in FIG. 5) formed by the first nucleating agent, the first foamed cell 14 having a hole diameter of from 10 μm to 1000 μm.

Furthermore, a microscopic foamed cell, which can be seen in the exemplary embodiment 1, cannot be seen in the cell walls of the foamed resin molded article 11 of the comparative example 2 shown in FIGS. 5 to 7.

From the result described above, the foamed resin molded article 1 of the present invention can have first foamed cells 4 reduced in size as compared with the foamed resin molded article 11 of the related art, which does not use the second nucleating agent, and can have many extremely microscopic second foamed cells 5 formed in the cell walls. In short, as compared with the foamed resin molded article 11 of the related art, foamed resin molded article 1 of the present invention can have the foamed cells decreased in hole diameter and increased in number.

The present inventor tries to consider the reason why the first foamed cells 4 in foamed resin molded article 1 of the present invention are smaller in size than first foamed cells 14 in foamed resin molded article 11 of the related art. It is assumed that the amount of gas produced in the base resin by the foaming agent is identical between foamed resin molded article 1 of the present invention and foamed resin molded article 11 of the related art. In the foamed resin molded article 11 of the related art, the produced gas generates bubbles due to the first nucleating agent. On other hand, in the present invention, the microscopic second nucleating agent is used in addition to the first nucleating agent, so that a portion of the produced gas generates bubbles due to the first nucleating agent and the other portion of the produced gas generates bubbles due to the second nucleating agent. In short, the produced gas is dispersed in the first nucleating agent and in the second nucleating agent to thereby generate the bubbles, so it can be thought that first foamed cells 4 are reduced in size. Furthermore, the particles of the second nucleating agent are extremely small in size and are uniformly dispersed in the base resin, so that the bubbles generated due to the second nucleating agent are small in size and are less likely to be combined with each other to generate large bubbles, so that as can be seen from FIG. 3 and FIG. 4, the second foamed cells 5 become small in size. From this, it can be thought that the second foamed cells 5 do not become large in size.

Next, differences in the physical property among exemplary embodiments 1, 2 and comparative examples 1, 2 were examined. First, a test method will be described.

### (Cold-Resistant Falling-Ball Impact Strength)

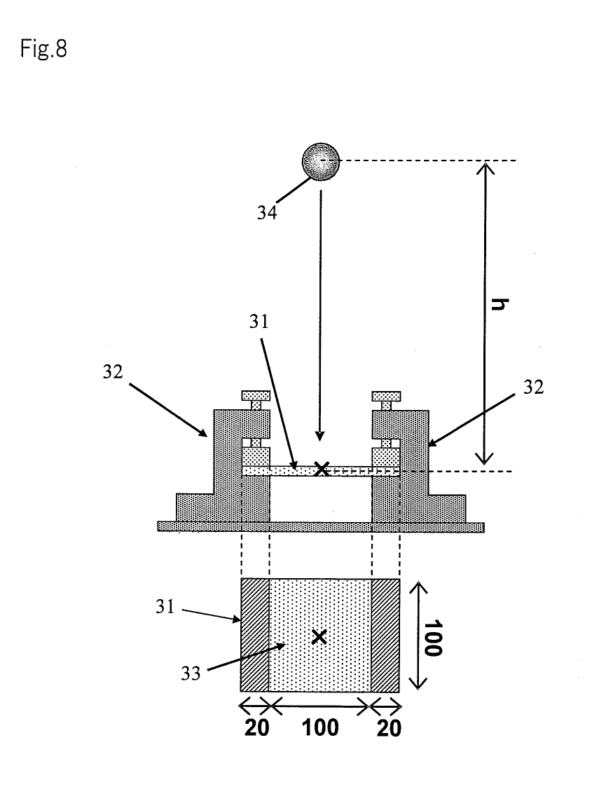

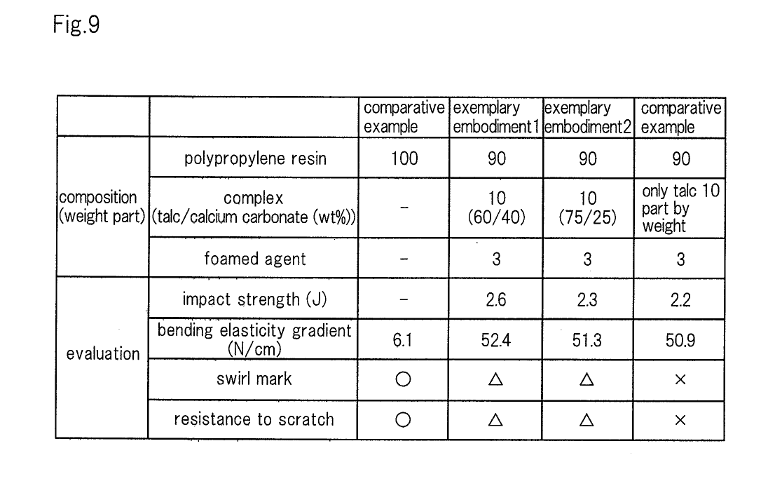

A test specimen 31 having length×width of 140 mm×100 mm was used which is cut out from a foamed resin molded article having a thickness of 3 mm. A test method is as follows: as shown in FIG. 8, both ends, that are 20 mm long in a longitudinal direction, of test specimen 31 were claimed and held by jigs 32 made of metal; impact face 33 is made from a portion that is exposed from jigs 32 and has a length×width of 100 mm×100 mm; a torque of 5N was applied to the jigs 32 so that test specimen 31 is held by the jigs 32; atmospheric temperature was −30° C.; and weight 34 having a spherical head part of radius 25 mm and a mass of 500 g was dropped on impact face 33 from above the center. These tests were performed by changing the height (h) at which weight 34 was dropped and five tests were performed from each height (h). After weight 34 was dropped, the condition of test specimen 31 was observed. When test specimen 31 was not changed or was whitened, test specimen 31 was evaluated to be “O”, whereas when the test specimen 31 was cracked or broken, test specimen 31 was evaluated to be “×”. From this test result, the height (h) at which the number of evaluations “O” became 50% was calculated and an impact strength was calculated from the height (h). These test results will be shown in FIG. 9.

### (Flexural Elasticity Gradient)

“JIS K 7171 Plastics—Determination of flexural properties” was employed as a test method and a flexural elasticity gradient was measured. The test specimen having length×width of 150 mm×50 mm was cut out in a resin flow direction (MD) and in a perpendicular direction (TD), which is perpendicular to the resin flow direction (MD), from a foamed resin molded article having a thickness of 3 mm. A test machine that had a support base having a radius of 2 mm and an indenter fixed thereto was used and tests were performed under conditions where the distance between supporting points was 100 mm and where the test speed was 50 mm/s. The test results were evaluated by the average of MD and TD and are shown in FIG. 9.

### (Swirl Mark)

The external appearance of the molded article was visually observed and the presence or absence of a swirl mark was evaluated according to the following standards. The swirl mark is caused as follows: that is, foaming is developed at a flow front at the time of molding and traces, in which the generated bubbles are dragged, are left on the surface of the molded article, thereby showing poor appearance. In the foaming injection molding, the swirl mark cannot be avoided but can be made less conspicuous as the foamed cells are smaller in diameter. The swirl mark was evaluated on the following standards: “O”=no problem; “Δ”=the swirl mark is almost inconspicuous (partially visible); “×”=the swirl mark is conspicuously visible. The test results are shown in FIG. 9.

### (Resistance to Scratch)

A molded article had scratches put thereon at intervals of 2 mm in a grid pattern at a scratch speed of 1000 mm/min by the use of a steel needle having a tip diameter of 1 mm, the steel needle having a load of 500 g applied thereto. Thereafter, the external appearance of the molded article was visually observed and the presence or absence of the scratches was evaluated according to the following standards: “O”=no problem; “Δ”=the swirl mark is almost inconspicuous (partially visible); “×”=the swirl mark is conspicuously visible. The test results are shown in FIG. 9.

When comparative example 1 of the resin molded article that is molded by simple injection molding is compared with exemplary embodiments 1, 2 and comparative example 2, which are foamed resin molded articles, exemplary embodiments 1, 2 and comparative example 2, which are foamed resin molded articles, are significantly larger in a bending elastic gradient than comparative example 1 of the simple resin molded article. In other words, it can be seen that exemplary embodiments 1, 2 and comparative example 2, which are foamed resin molded articles, are significantly enhanced in rigidity as compared with comparative example 1 of the simple resin molded article.

When comparative example 2 is compared with exemplary embodiment 1 and exemplary embodiment 2, it can be found that exemplary embodiment 1 and exemplary embodiment 2 are more resistant to impact than comparative example 2.

It can be thought that excellent resistance to impact of exemplary embodiment 1 and exemplary embodiment 2 is due to the second foamed cells caused by the nano-sized second nucleating agent.

It can be found that the swirl mark and the resistance to scratches exemplary embodiment 1 and exemplary embodiment 2 are upgraded as compared with the comparative example 2. In other words, exemplary embodiment 1 and exemplary embodiment 2 are improved in design as compared with comparative example 2. In this way, in the foamed resin molded article of the present invention, the amount of paint can be reduced as compared with the foamed resin molded article of the related art and hence cost can be reduced. Furthermore, the foamed resin molded article of the present invention can be applied to wide variety of products and purposes.

From the test results described above, it is preferable that the weight ratio of the first nucleating agent and the second nucleating agent in the complex is from 75:25 to 60:40. Furthermore, it is preferable that the complex is mixed in the mixture at the ratio of 10 or more parts by mass of the complex to 100 parts by mass of the base resin.

The above descriptions of the specified embodiments of the present invention are presented for the purpose of showing the examples. It is not intended to limit the invention to the described embodiments as they are described. It should be obvious to those skilled in the art that many modifications and alterations can be made in view of the contents described above.

This application is based upon and claims the benefit of priority from Japanese patent application No. 2011-101712, filed on Apr. 28, 2011, the disclosure of which is incorporated herein in its entirety by reference.

### DESCRIPTION OF REFERENCE NUMERALS AND SIGNS

1, 11 foamed resin molded product
2, 12 skin layer
3, 13 foamed layer
4, 14 first foamed cell
5 second foamed cell

1. A foamed resin molded article comprising:
a skin layer for forming a surface; and
a foamed layer for forming an interior,
wherein the foamed layer consists of a plurality of first foamed cells and a plurality of second foamed cells which are formed between the first foamed cells and which are smaller than the first foamed cells.

2. The foamed resin molded article according to claim 1, wherein the first foamed cell has an average hole diameter of from 10 μm to 1000 μm, and wherein the second foamed cell has an average hole diameter of from 10 nm to 1000 nm.

3. The foamed resin molded article according to claim 1, comprising:
a first nucleating agent for forming the first foamed cells; and
a second nucleating agent for forming the second foamed cells.

4. A method for molding a foamed resin molded article, the method comprising:
a step of attaching a second nucleating agent smaller than a first nucleating agent to a surface of the first nucleating agent to thereby form a complex of the first nucleating agent and the second nucleating agent;
a step of mixing a resin and a foaming agent with the complex to thereby form a mixture; and
a step of molding the mixture by injection foam molding process.

5. The method for molding a foamed resin molded article according to claim 4, wherein the first nucleating agent has a particle diameter of from 0.5 μm to 1000 μm, and wherein the second nucleating agent has a particle diameter of from 10 nm to 500 nm.

6. The method for molding a foamed resin molded article according to claim 5, wherein the first nucleating agent has a particle diameter of from 1 μm to 10 μm, and wherein the second nucleating agent has a particle diameter of from 50 nm to 100 nm.

7. The method for molding a foamed resin molded article according to claim 4, wherein the first nucleating agent and the second nucleating agent are inorganic substances.

8. The method for molding a foamed resin molded article according to claim 7, wherein the first nucleating agent is talc and the second nucleating agent is calcium carbonate.

9. The method for molding a foamed resin molded article according to claim 4, wherein the second nucleating agent is subjected to surface treatment in such a way as to have hydrophobicity.

10. The method for molding a foamed resin molded article according to claim 4, wherein a weight ratio of the first nucleating agent and the second nucleating agent in the complex ranges from 75:25 to 60:40.

11. The method for molding a foamed resin molded article according to claim 4, wherein the complex is mixed in the mixture at the ratio of from 1 to 80 by mass % of the complex to the base resin.
